(19) United States
(12) Patent Application Publication
(10) Pub. No.: US 2009/0044990 A1
(43) Pub. Date: Feb. 19, 2009

(54) Screw driven mobile base

(76) Inventor: Timothy Carl Lexen, Cumberland, WI (US)

Correspondence Address: Timothy Carl Lexen, 1685 Second Avenue North, Cumberland, WI, 54829, US

(21) Appl. No.: 11/893,564

(22) Filed: Aug. 17, 2007

(51) Int. Cl. B62D 57/036

(52) U.S. Cl. 180/7.2

(57) ABSTRACT

The present invention is a screw driven, mobile base for traversing a wide range of outdoor soft or rough surfaces and terrains. The device has three degrees of freedom in a plane and, thus, is highly maneuverable, able to travel in any horizontal direction relative to its orientation and able to orient itself independently of the direction of travel. Each screw comprises a structural core with an outer helical edge profile of curved cross-section, having an abrasion resistant, low friction material on the outer surface. The device rides on the low friction profiles and relies on the combined effects of the multiple drive screws against the ground surface. The drive screw axes are non-parallel in most of the configurations.

### CROSS-REFERENCE TO RELATED APPLICATIONS

Not Applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The invention relates generally to a self propelled, all-terrain, omni-directional/3DEGREE OF FREEDOM, highly maneuverable device for use on soft or rough ground surfaces.

2. Background Information

A three degree of freedom drive system on a robot or vehicle allows motion in any direction in a plane and rotation, independently, or together. Drive systems for three degree of freedom vehicles or rovers for outdoor use have used concepts from three categories summarized in the three paragraphs below.

The drive system may use standard wheels, usually in the form of casters. Either the caster rotation is powered separately or, in another design, one or two wheels of each caster are offset and powered. The problems which arise in using this kind of system outdoors are: the need for a sophisticated suspension; the complexity of controls, linkages, gears and extra motors; turning friction beneath each wheel; and the height of assembly needed, in that the vehicle is usually not compact in height.

Alternately, the drive system may use special wheels, which have been used indoors for the past 30 years. Universal wheels, also known as omni-directional roller wheels, contain passive, rolling components placed orthogonal to the driven direction, so the wheels can roll freely in this orthogonal direction. The Meccanum wheel is similar to the universal wheel, but the rollers are oriented at 45 degrees to the plane of the wheel. The Meccanum wheel is used in CMU's Robotics Institute's Uranus robot. Along the same principle, there are tracks with rollers or spheres that allow vehicle motion in the perpendicular direction. These special wheels or tracks are all designed to run on flat, hard surfaces. These vehicles encounter problems in outdoor environments, such as dealing with dirt and uneven terrain, low obstacle climbing ability and overall complexity.

Lastly, the drive system may use a parallel screw drive, many of which were patented over the past 100 years. However, these screw driven vehicles do not possess true omni-directional/3DEGREE OF FREEDOM capabilities. These vehicles typically are heavy, with powerful engines required to overcome high friction. The edge of each screw is apparently bare metal, which digs into the earth. All previous designs have used parallel, counter-rotating screws, with the exception of one case in which four orthogonal screws are present.

Some examples of inventions concerned with mobile vehicles for which patents have been granted are found in the following. Sibley et al., in U.S. Pat. No. 661,427, describe a sled with pairs of parallel driving drums with spiral flanges for contacting the snow or ice. The driving drums appear to rotate in opposite directions.

In U.S. Pat. No. 669,210, Burch discloses another ice locomotive with pairs of parallel screws arranged helically on shafts. The helical screw tapers from the middle of each shaft toward each end. The screw includes a replaceable skate or rail at the outer edge that is replaceable when showing wear. Each screw-shaft is driven by separate engines to provide different speeds to effect turning. Rudder disks are also employed for steering.

Peavy, in U.S. Pat. No. 864,106, describes another snow locomotive having front and rear pairs of parallel hollow drums with screw flanges. Each drum of a pair rotates in opposite directions. The front pair of drums can be turned relative to the rear pair to achieve steering.

In U.S. Pat. No. 1,228,093, Birch discloses a motor sled having front and rear pairs of parallel parabolic hollow metal cylinders with screw flanges. The screw flanges on one side of the sled are right-handed while the screw flanges on the other side of the sled are left-handed. A similar snow motor vehicle is described by Birch in U.S. Pat. No. 1,431,440.

Howell, in U.S. Pat. No. 1,672,613 discloses a land and water vehicle having pairs of drums with their axis of rotation perpendicular to the direction of movement. The drums have angular screw thread portions that operate as treads for the drums.

Welsh, in U.S. Pat. No. 2,154,191, describes a watercraft having a pair of parallel pontoons that have spiral or screw blades. Rotating the pontoons powers the craft. Front and rear rudders are provided for steering the craft in the water.

U.S. Pat. No. 2,254,320 by Russell shows an ice skate blade with a motor driven spiral screw on the blade. No means for steering the skate blade is shown, nor is variation in speed mentioned.

In U.S. Pat. No. 2,495,643, Pidgeon discloses an aircraft flying boat having two pairs of parallel pontoons, with one of each pair on each lower side of the fuselage. The pontoons have a central shaft with a spiral rotor that decreases in diameter toward each end of the pontoon. The rotor is covered with a flexible sheet material to provide buoyancy when inflated with air. No steering mechanism is provided.

U.S. Pat. No. 2,706,958 by Cutting et al. describes a rotary hull vehicle having a pair of parallel pontoons that have multiple, spirally wound fins with right-handed orientation on one pontoon and left-handed orientation on the other pontoon. The drive mechanism rotates both pontoons at the same rate, and a steering rudder is provided.

Wright, in U.S. Pat. No. 3,169,596, describes a step traversing wheel chair fitted with a pair of propulsion screws each on a shaft. The screws engage stair steps to move the wheel chair up or down the flight of steps. No steering is involved.

U.S. Pat. No. 3,229,658 by Schrader describes an amphibious vehicle having a pair of parallel tapered cylindrical members that have spiral vanes with the members rotating in opposite directions. There are control levers to individually change the direction of rotation of each member to effect changes in the direction of movement of the vehicle.

Garate, in U.S. Pat. No. 3,250,239, describes another amphibious vehicle having four rotors with cylindrical and conic shaft sections and two helicoidal fins or screws. The four rotors are each mounted on a vertical shaft and can be oriented to allow the vehicle to travel on land or water. A single engine powers all rotors, and compressed air is used in conjunction with mechanical systems for steering the vehicle.

U.S. Pat. No. 3,333,563 by De Bakker describes an amphibious vehicle having a pair of parallel pontoons, each having helical ribs of opposite handedness on their outer peripheries. The pontoons rotate in either direction for movement and turning. Also, the vehicle has a means for adjusting the angle between the axes of the pontoons for control when moving on the land.

U.S. Pat. No. 3,369,514 by Cockerell shows a watercraft driven by two rotatable vanes of helical form, rotating in opposite directions by hydraulic power. The angle between the vanes can be varied by pivoting the vanes relative to each other.

Itoh et al., in U.S. Pat. No. 3,381,650, describe another amphibious vehicle having two pairs of parallel floating screw rotors, each having helical fins with outer tapered ends. The helical fins of the rotors adjacent each other are wound in the same direction, while the helical fins of the rotors diagonal from each other are wound in the opposite direction.

U.S. Pat. No. 3,396,690 Tsunazawa describes a similar amphibious vehicle having two pairs of parallel floating screw rotors each having helical fins with outer tapered ends. A power transmission drives all four screw rotors.

Nelson, in U.S. Pat. No. 3,418,960, describes a wheeled amphibious vehicle with the wheel rotational axes perpendicular to the direction of travel. The wheels have a hub and are provided with rigid webs or fins providing traction with soil or water. The fins or webs are sectioned for adjusting the orientation of the sections relative to the hub.

U.S. Pat. No. 3,420,326 by Kusmer describes a land vehicle propulsion system having two pairs of rotatable ground engaging screws. The screws have their axes offset by an acute angle to opposite sides of the axis of the vehicle direction of travel. The axis of each screw intersects the axes of two other screws. The screw pairs are selectively rotated in opposite directions.

Allen, in U.S. Pat. No. 3,591,241, describes another vehicle propulsion system which has a plurality of roadway-engaging rollers arranged in a helical path around an axis parallel to the direction of movement of the vehicle. There are controls for shifting the rollers into any desired helical path to affect an infinitely variable transmission ratio. This is a Meccanum wheel.

U.S. Pat. No. 3,746,112 by Ilon describes another vehicle propulsion system to propel the vehicle in any desired direction. The vehicle includes at least two front and two rear rotatable driving gears having ground contacting elements mounted obliquely to the axes of rotation of the driving gears. The ground contacting elements are mounted so the ground contact lines for the front set of gears intersect in the backward direction, and the ground contact lines for the rear set of gears intersect in the forward direction. This is also a Meccanum wheel.

Wier et al., in U.S. Pat. No. 4,258,815, describe an ambulatory drive mechanism for a mobile platform, suitable for a standing individual. The drive mechanism includes a set of four wheels with each wheel mounted at a corner of a rectangular base. Each wheel has a vertical axis of rotation and has a plurality of spaced, freely rotatable rollers around the wheel periphery. Each wheel is slightly inclined so that during rotation one or two of the outermost rollers of each wheel assembly contact the surface at a time. Each wheel is powered by a DC motor and controllable to rotate in either direction.

U.S. Pat. No. 4,476,948 by Komoto et al. describes an amphibian vehicle with one or two pairs of parallel floaters with helical blades for propelling the vehicle through the water and ice. The blades include a wear resistant portion that may be replaced.

Farnam, in U.S. Pat. No. 4,926,952, describes a wheelchair having two compound wheels at the front end thereof. The compound wheels allow the front end of the wheelchair to roll substantially free from side to side in addition to forward and backward. The compound wheels have two rows of castors around the periphery to provide multidirectional movement of the front.

U.S. Pat. No. 5,186,270 by West describes a vehicle having parallel, spaced apart tracks driven independently in a first direction. Each track contains a plurality of spaced apart spheres, with the spheres driven in a second direction perpendicular to the first direction. Thus, the vehicle can move in the X and Y directions and rotate about the Z axis.

Kovacs et al., in U.S. Pat. No. 5,509,370, describe another amphibious vehicle having a pair of buoyant pontoons that have oppositely wound spiral flutes, such that rotation of the pontoons drives the vehicle through the water.

U.S. Pat. No. 5,701,966 by Amico describes an omni-directional self-propelled vehicle for ground handling of equipment. The two-part vehicle has a pair of independently driven omni-directional wheels secured to each part. The wheels are of the Meccanum wheel variety. Additional stabilizing elements are present to steady a supported aircraft on the vehicle.

Chhabra et al., in U.S. Pat. No. 6,179,073, describe another tracked vehicle having a pair of hybrid track assemblies mounted on opposite sides of the longitudinal axis of the vehicle. Each track assembly includes pairs of lead tracks, with each lead track having multiple rollers arranged in opposite directions, i.e., a herringbone configuration. By independent drive of each of the four tracks to provide various combinations of drive directions and speed for each track, the force vectors, created by the rollers engaging the surface, add and subtract to effect movement in any direction.

### BRIEF SUMMARY OF THE INVENTION

The present invention is directed to a device for traversing outdoor rough or soft terrain, as an all-terrain platform, with omni-directional, three-degree-of-freedom capabilities. There is a need for a device that is highly maneuverable, simple and reliable, for remote or autonomous control over rough and soft terrain. This includes the use of robots and remotely operated vehicles for hazardous areas, police work, surveillance, exploration, and moving equipment.

The invention uses at least three drive screws, some of which are not parallel, and which contact the ground. Each drive screw includes an outer helical edge profile of curved cross-section, with an abrasion resistant, low friction material on the outer surface. Each drive screw is supported by a frame, driven independently by a power system and controlled in coordination with the other drive screws. The device rides on the low friction helical edge profiles of the drive screws and relies on the combined effects of the multiple drive screws against the ground surface.

It is a primary object of the invention to provide a mobile base with three degree of freedom capabilities in an outdoor, all-terrain environment.

It is a further object of the invention to provide a mobile base that has redundant systems, so it can travel and maneuver even when some of its rotating elements are not working.

It is a further object of the invention to provide a mobile base that is simple in design, with a minimum of moving parts.

It is a further object of the invention to provide a mobile base that has improved traction over rough or soft terrain and improved obstacle climbing ability.

It is a further object of the invention to provide a mobile base that has multiple operating modes.

It is a further object of the invention to provide a mobile base that in some configurations has minimum suspension and low profile, so that that it can flip over and operate upside down.

The above summary of the present invention is not intended to describe each illustrated embodiment or every implementation of the present invention. The figures and detailed descriptions that follow more particularly exemplify these embodiments.

### BRIEF DESCRIPTION OF THE SEVERAL VIEWS OF THE DRAWING

The invention may be more completely understood in consideration of the following detailed description of various embodiments of the invention in connection with the accompanying drawings, in which:

FIG. 1 is an isometric view of one embodiment of the invention having three drive screws, from the top corner, with the frame plate shown in phantom.

FIG. 2 is a top view of the embodiment of FIG. 1.

FIG. 3 is a side view of the embodiment of FIG. 1.

FIG. 4 is an enlarged side view of a single drive screw, motor and platform portion of FIG. 3.

FIG. 5 is an enlarged sectional view A-A of the auger core and helical edge profile of FIG. 2.

FIG. 6 is a sectional view A-A of the auger core and helical edge profile showing an alternative cross-section shape.

FIG. 7 is a sectional view A-A of the auger core and helical edge profile showing an alternative cross-section shape.

FIG. 8 is a sectional view A-A of the auger core and helical edge profile showing an alternative cross-section shape.

FIG. 9 is sectional view A-A of the auger core and helical edge profile showing an alternative cross-section shape.

FIG. 10 is a top view of the alternative embodiment with four screws

FIG. 11 is a top view of the alternative embodiment with four screws

FIGS. 12, 13, and 14 are top views of three alternative embodiment layouts, each having three drive screws, shown without the rotary power systems or platforms.

FIG. 15 is a side view of another embodiment of the drive screw connected to a rotary power system.

FIG. 16 is a side view of yet another embodiment of the drive screw connected to a rotary power system.

FIG. 17 is a side view of yet another embodiment of the drive screw connected to a rotary power system.

FIG. 18 is a bottom view of an alternative embodiment of the invention having four drive screws.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention, as defined by the appended claims.

### DETAILED DESCRIPTION OF THE INVENTION

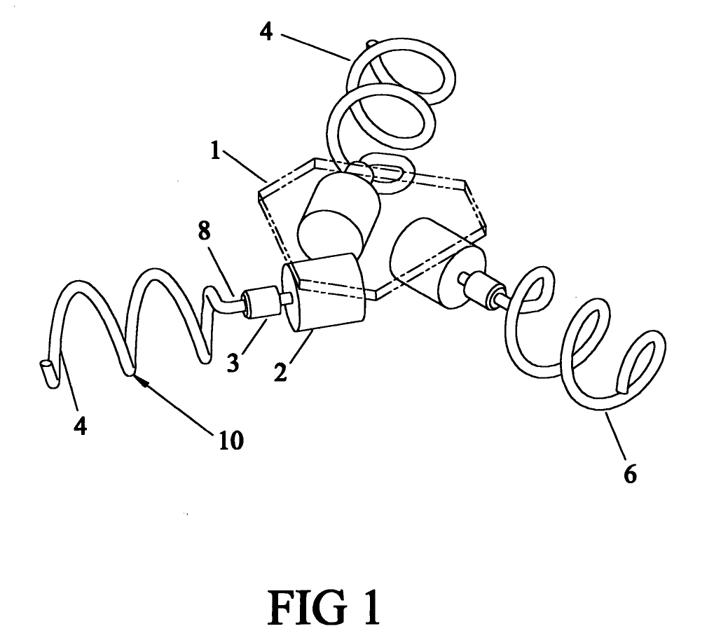

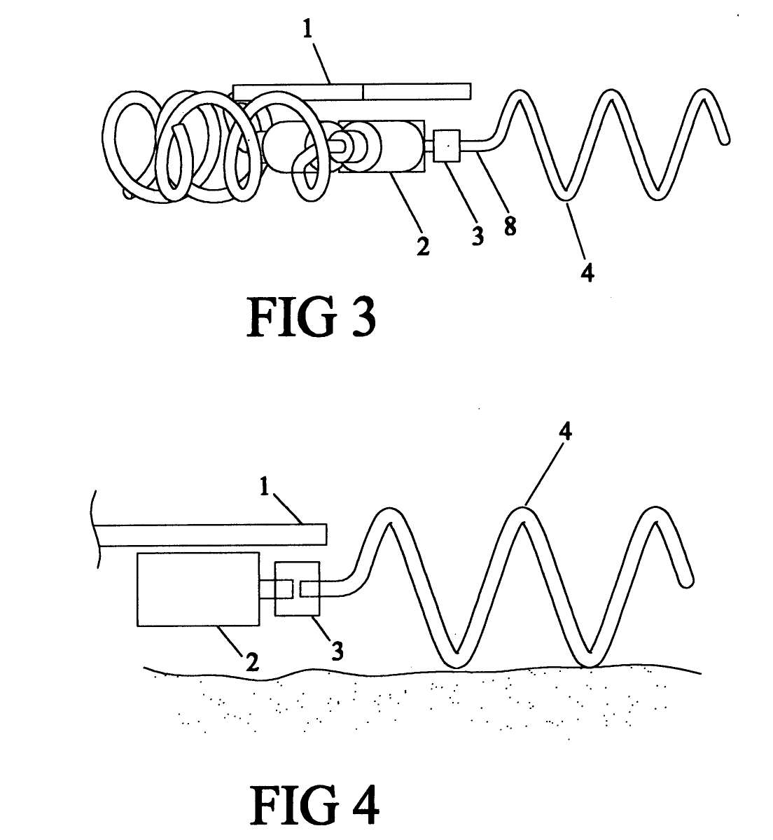

Referring to FIGS. 1-5, one embodiment of the device is shown. A central frame plate 1 supports three electric motors 2. The output shaft of each motor is connected by a coupling 3 to the central shaft 8 at one end of the drive screw 4.

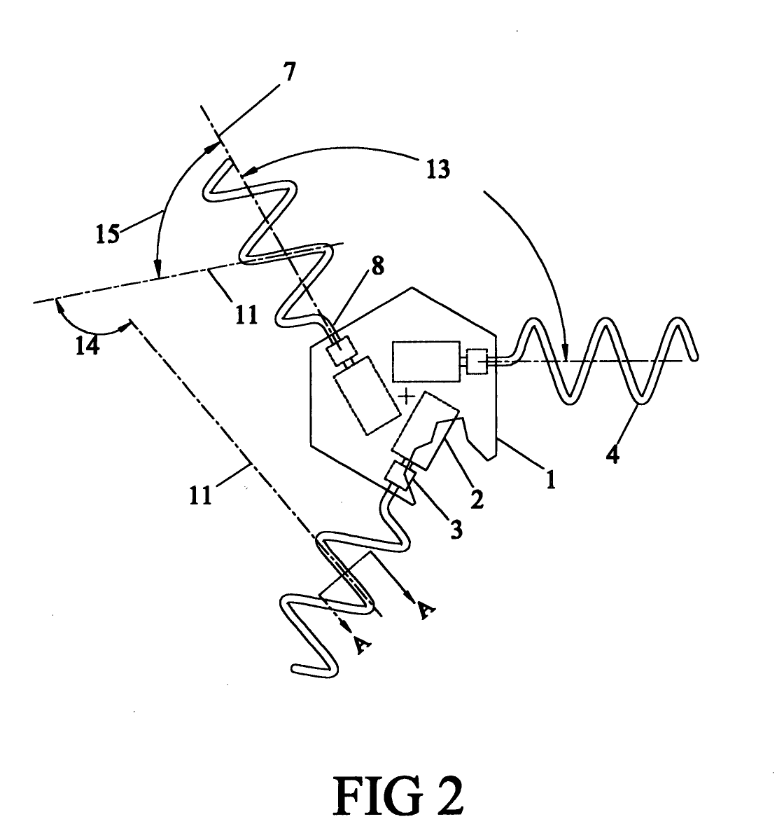

The drive screw 4 consists of a helical coil shape of circular cross-section 12, with a central shaft 8 only where it connects to the coupling 3, with a hard, abrasion-resistant, low-friction (e.g., chrome) coating 9 on the spring material forming a outer helical edge profile 6 that normally contacts the ground surface. The helical coil shape 10 follows a cylindrical right hand helix of constant helix angle 15 relative to drive screw axis 7 (FIG. 2). The helical coil shape 10 and the coil cross-section 12 structurally support, and transmit motor torque to, the helical edge profile 6. At the end of each drive screw 4, the helix radius is preferably reduced so the end of the helix does not catch in the ground.

The frame plate 1 has the function of holding the three motors 2 and drive screws 4 in the proper relationship, nominally in the same plane and with the desired angle between adjacent drive screw axes, adjacent axes angle 13 (FIG. 2). In the embodiment of FIGS. 1-3, the angle between the drive screw axes 7 is about 120 degrees, but this is not critical. That is, the adjacent axes angle 13 is 120 degrees. Each drive screw 4 has a ground tangent line 11, tangent to the helical edge profile 6 where it contacts a flat level ground surface, as illustrated in FIG. 2. In this embodiment, because the drive screws 4 are identical, the angle between the ground tangent lines 11 of two adjacent drive screws, termed the adjacent line contact angle 14, is also 120 degrees.

The frame plate 1 is shown in the figures as a flat metal plate. The motors 2 are each fastened to the frame plate 1 by a fastening means. The fastening means can be any means that accomplishes the result, for example, bolting an integral motor housing foot to the frame plate 1.

The electric motor 2 supplies the rotational power, with the required speed and torque at the output shaft. It is shown here as a DC gear motor, i.e., with integral, collinear gearbox. The three motors 2 are identical. In this embodiment the motors 2 and base 1 together provide the structural and orientational connection between the drive screws 4.

The spring coupling 3 connects the output shaft of the motor 2 to the shaft 8 of the drive screw 4, with a standard shaft fastening means such as setscrew, key/keyway, or integral clamp. The coupling may be quite rigid, and it performs the function of reducing the shock transmitted to payload and motors, shaft and bearings. The gear motor 4 and the coupling 3 together can be considered a rotary power system.

FIG. 4 shows an enlarged sectional view of one flight of a drive screw 4 contacting the ground. The motion of the device depends on the side of the helical edge profile 6 pushing against the ground material.

### Operation

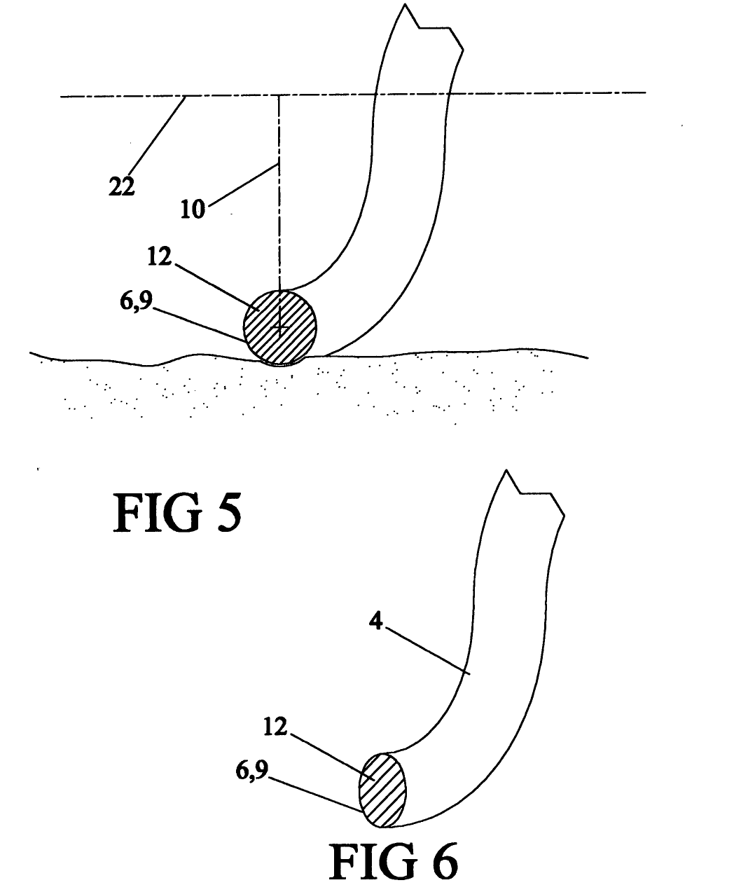

The device moves across the ground surface due to the action of the drive screws 4 against the ground. FIG. 5 is an enlarged sectional view A-A, perpendicular to the coil cross-section 12 and helical edge profile from FIG. 2, at the point where it contacts the ground surface. Note that the edge profile 6 either 1) sinks into the ground material some amount, creating its own depression, against which side it pushes, or 2) catches on rough features of the ground surface.

The direction of motion of the device is determined by the relative speed of the drive screws 4. The device of the present invention moves in a straight line in any direction by the appropriate balancing of the screw speeds.

The device of the present invention can be made to spin in place, turn in any arc, or spin to change orientation while moving in a straight or curved line. These actions are achieved by controlling the three motors 2 separately. One result of this capability is that the device can be oriented, either at rest or on-the-fly, to use the most effective drive screw arrangement, in order to optimize efficiency, traction, stance, or speed. This takes advantage of orientation differences, such as:

(a) the drive screws having different diameters, different helix angles, or different edge profiles;

(b) differences in traction, stability, or efficiency due to the arrangement of the drive screws. For instance, one of the screws can be longer than the others and used as an outrigger or brace of sorts and positioned, for example, on the downhill side of a slope;

(c) the drive screw profiles being different on each side of the flight to give a different effect going forward and backward, for example, more digging in or perhaps, deliberately, more slippage;

(d) the outboard end of each drive screw 4 having some feature to allow the device to surmount obstacles. For example, if the outer end of the helix does not have a reduced radius, the end can be made to catch over the top surface of, say, a step, and then the drive screw can be turned to lift the drive screw 4 to the top of the step. Even with the reduced helix radius at the end of the screw, this action can be used to surmount abrupt objects, up to approximately 80% of the height of the screw;

(e) the device having some feature, equipment or sensor mounted on the frame plate, which requires pointing in various directions. In this case, a separate rotation system, such as a turntable or turret, can be eliminated.

The three degree of freedom capabilities are more useful in an uneven, outdoor environment than on a uniform, indoor flat surface, since the device benefits from having more options when dealing with obstacles, soft material, and other discontinuities, and the device is less likely to get stuck in soft material.

The device of the present invention has multiple operating modes, being able to travel straight or turn in different ways. For instance, the device can turn by braking one screw, speeding up one or two screws, or changing the speed of all three screws. It can go straight by any number of screw speed combinations.

The use of the screw in this invention also gives an advantage in dealing with soft and rough terrain. The screw provides a “stepping over” action, in which some obstacles up to a large fraction of the screw's height (with an open coil spring design) may be stepped over with the screw, instead of having the whole diameter of the screw pass over the obstacle. Also, this action can be used to grip the top or side of an obstacle and provide traction under conditions, such as climbing curbs. Further, this can also be used when the material is soft and deep and the screw sinks into the terrain. Progress can be made even when the screws are approximately 30% buried.

The ideal surface allows the drive screws 4 to both slip and dig in, including grass, dirt, sand, mud, gravel, snow, and carpet. Generally, the device is not intended for travel on smooth or hard, flat surfaces, because the drive screws 4 are unable to dig into the surface material. In addition, the drive screws 4 may damage the surface over which they travel or be damaged by excess friction, such as on cement or blacktop. The exception is the case where there are three screws, with two-fold polar symmetry, in which limited travel over smooth or hard, flat surface is attainable.

The device of the present invention includes redundant systems so it can travel and maneuver even when some of its rotating elements are not working. The preferred embodiment, containing three screw drives 4, can run on any two screws 4, with the third screw not rotating. The device can also function with a degraded control system, in that it is maneuverable even with simple forward-off-reverse controls.

An electrical control system provides electric power and speed control to each of the motors 2, separately and in coordination. The device may be autonomous, semi-autonomous, or remotely controlled for instance by radio signals, with electronic circuits to coordinate motor activities. The control circuitry may be aided by devices such an electronic compass, an electronic gyroscope, or accelerometers.

### Modifications

Modifications are contemplated to the present invention that are limited in scope only by the claims appended hereto.

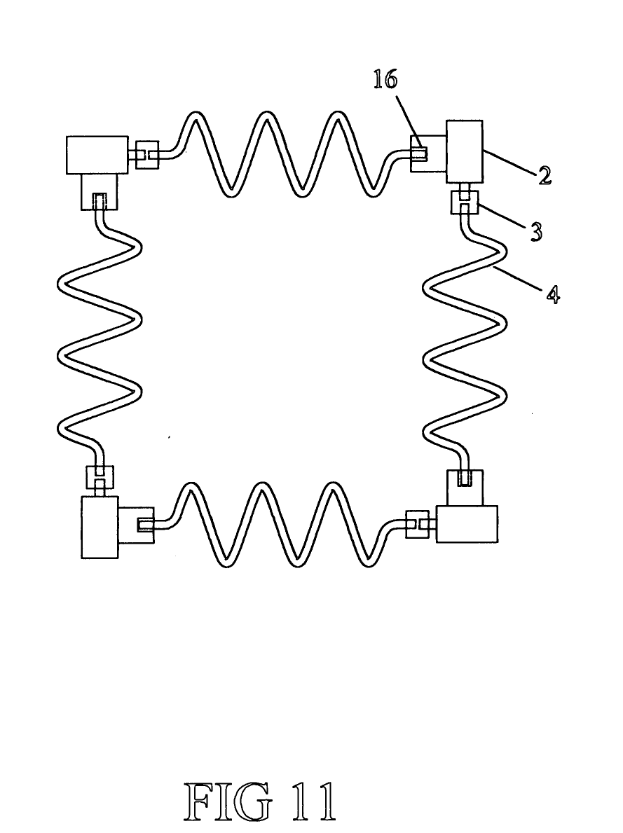

It is clear that there are many possible variations in the frame. For example, the frame 1 can vary considerably, depending on the type of motor 2 and its mount, drive screw 4 construction and drive screw arrangement. In particular, the frame 1 need not be a flat plate at all, but any structure to hold the motors in the desired position. In addition, the frame 1 does not need to be on top of the motors 2. The frame 1 can be centered vertically on the motor centerlines and, thus, the device is symmetrical and can operate equally well upside down, if flipped over. Further, with the appropriate design and material, the frame 1 may be flexible enough to provide the suspension function. In addition, the frame 1 may even be eliminated, as illustrated in FIG. 11. FIG. 11 shows a layout in which the axis of the free end of each drive screw 4 is attached via a rotating joint 16 to the motor casing of another drive screw 4. This configuration preserves the right angle relationship between drive screws 4, while allowing some pivoting movement to enable the screws 4 to conform to the ground by their own weight. Thus, the spring suspension is eliminated, and the layout is more compact.

It is clear that there are many possible variations in the rotary power system, which is the combination of motor 2 and a power transmission system or element. In the preferred embodiment, the rotary power system consists of the gear motor 2 and the coupling 3. The motor 2 can be connected to any of a variety of torque increasing power transmissions systems, such as gears, pulleys, or gearboxes, as well as any of a variety of systems to transmit rotary motion from the motor 2 to the drive screw 4, such as flexible shafts, right angle drives, etc. For instance, the motors 2 can be other than electric, such as hydraulic or pneumatic, and accompanied by some increased complexity and size in the power and control systems. A totally pneumatic system can be useful in environments where one does not want electric sparks or electromagnetic interference. In addition, a motor 2 may have an attached gearbox in any of various arrangements, such as right angle or offset, and not necessarily collinear. In particular, a right angle drive with each motor 2 allows a more compact design in the horizontal dimensions. Further, each motor 2 can be nested inside its drive screw, much in the same manner of motorized conveyor rollers. Additionally, in the case of straight-line motion, the drives of the opposite and parallel drive screws 4 can be coupled with a clutch, to drive both screws 4 with one motor 2, or use both motors 2 in synchrony. Further, the motor 2 can be of such a design as to allow control of either or both the angle of rotation and torque, as is available in stepper and servo motors. In addition, the motor 2 might not require a gearbox.

It is clear that there are many possible variations in the suspension system. The motor 2 can be pivoted at its back end and use a spring somewhere further outboard. A shock absorbing function may be added. The drive screw 4 can be supported at each end of the screw, with the suspension components at either or both ends. Another variation is shown in FIG. 11, where the drive screws are arranged in the form of a square or rectangle, with no common mounting plate, in which case a suspension system may not be needed.

In addition, it is apparent that other modifications are also satisfactory in the drive screw 4 parameters, such as the outer surface diameter and the number of turns. In addition, the drive screw 4 can have multiple threads; for instance, with double threads there are two helixes, making the drive screw 4 more compact. A further step in this direction is multiple threads, twelve or sixteen for example, with short screw segments. Further, the drive screws 4 may have a left hand helix.

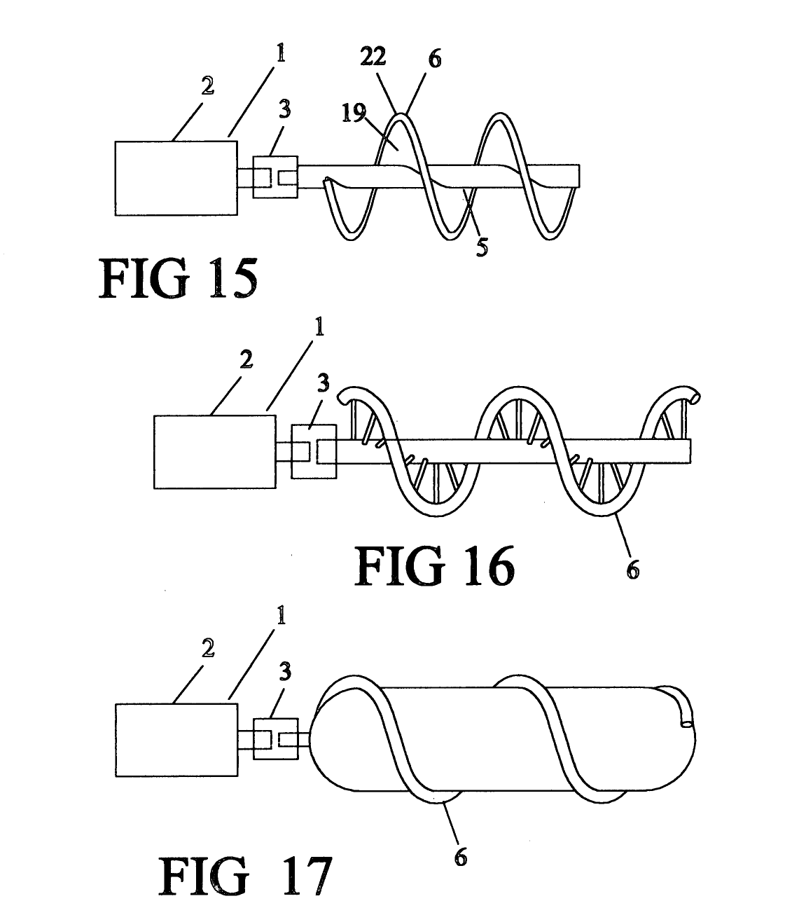

In addition, it is apparent that other modifications are also satisfactory in the drive screw construction. For example, the drive screw 4 can be a single piece similar to a commercially available molded polyethylene auger. Alternatively, the drive screw 4 can consist of a structural auger core 5 with flighting 19 of cylindrical right hand helix structurally supporting, and transmitting motor rotation/torque to, an integral or separate but attached cross-section 12 that is round, forming a helical edge profile 6 as shown in FIG. 15. Furthermore, the means of supporting the helical edge profile 6 from a central screw axis tube or rod may be intermittent, in the form of spokes or partial flighting as shown in FIG. 16. Alternatively, the inner structure of the drive screw 4 can consist of a buoyant, sealed cylinder having rounded ends, with a helical edge profile 6 on its outer surface. As illustrated in FIG. 17, such a drive screw structure is suitable for use in snow, sand or water environments.

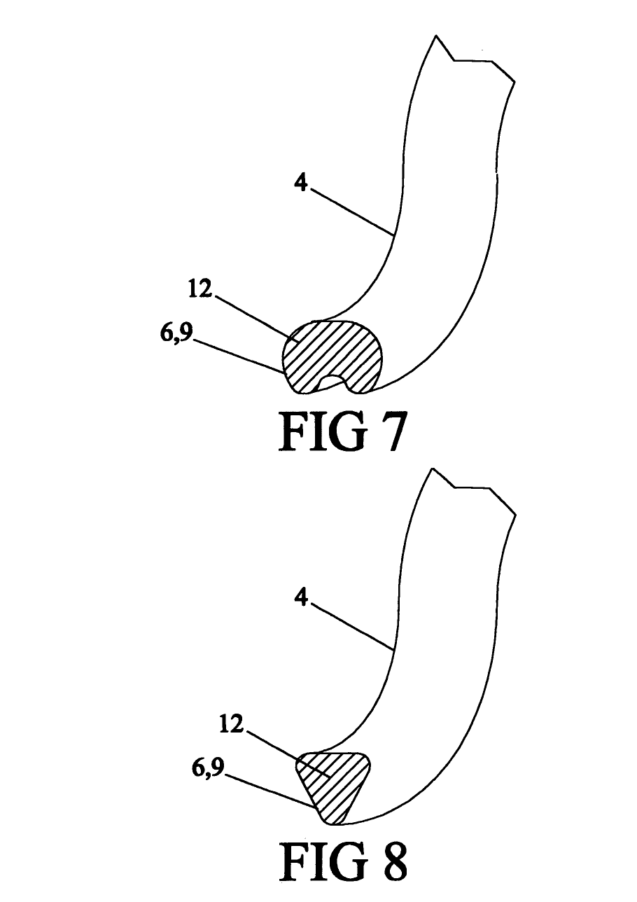

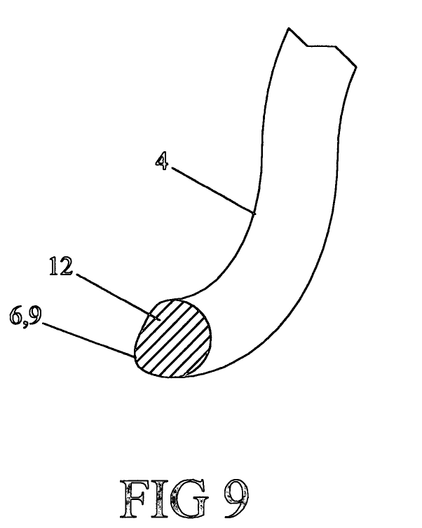

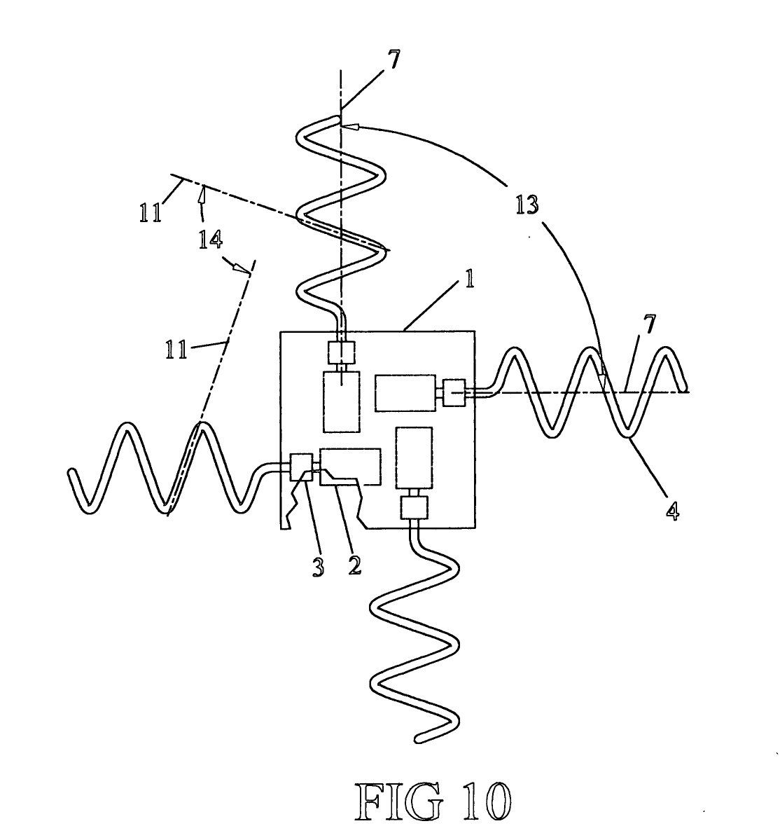

It is clear that variations in the shape and size of the coil cross-section 12 and its helical edge profile 6 are available. In all cases the extent of the helical edge profile 6 is that portion on the outer surface of the cross-section 12 which can come into contact with a ground surface or obstacles. Depending on the ground material and conditions, the helical edge profile 6 diameter is preferably in the range of ⅛th to 1/20th of the drive screw 4 outer diameter. On prototypes, a helical edge profile 6 diameter of about ½″ seems to work well. Also, the coil cross-section 12 need not be circular, as depicted in FIG. 5. FIG. 6 shows a symmetrical, oval cross-section; FIG. 7 shows a cross-section that has two lobes; and FIG. 8 shows a triangular cross-section with radiused bottom and angled sides. The helical edge profile 6 and the cross-section 12 shape inside it may be symmetrical with respect to a profile center line 10 connecting the center of the edge profile 6 or centroid of the cross-section 22 shape to the screw axis 7, or unsymmetrical as shown in FIG. 10. All these cross-sections 22 and edge profiles 6 can be modified for use with an underlying auger structure or an underlying sealed cylinder structure. In addition the cross-section 12 may be hollow, and it also may be partial as long as it adequately supports the helical edge profile.

In addition it is clear that there are satisfactory modifications in the means of maintaining a hard, wear-resistant, low friction surface coating on the outside of the helical edge profile 6. A surface treatment or coating can be used on any of a number of substrates. For example, the helical edge profile 6 can be coated with an organic polymeric material, such as nylon or Teflon®. Likewise, various metallic coatings, such as chromium, nickel, ceramic, nitride, carbide, or diamond composite particles, can be applied by hard facing, vapor phase deposition, ion beam, electrochemical or various other coating or deposition methods. Alternately, there can be a cushioning layer of material between the outermost profile surface and an inner material. Alternately, some thickness of low friction plastic material in the shape of the profile may be attached to a underlying structural core.

It is clear there are possible variations in the arrangement and quantity of drive screws 4. Two or more drive screws 4 will function in a variety of arrangements, if one accepts some limitations and inefficiencies. There is better performance and efficiency where the drive screw 4 arrangement has some symmetry and the drive screws 4 are either parallel or at right angles. There are four additional main variations, as follows:

(1) 4 screws with 2-fold polar symmetry
The arrangement having two screws parallel and the other two perpendicular is shown in FIG. 10. Opposite motors 2 and drive screws 4 are parallel, but staggered in a more compact design. The four drive screws 4 can be arranged in a variety of ways with 2-fold or 4-fold symmetry about the central vertical axis, with opposite drive screw pairs parallel. This allows for a wide variety of layouts: square, rectangular, star, “H”, etc. With the adjacent line contact angle 14 at 90 degrees, the device can travel straight with two parallel screws driving and two sliding as runners with minimum resistance. Note that the same principles apply when more drive screws are added, in pairs, while maintaining the two-fold polar symmetry. Aslo see previously mentioned FIG. 11 showing an alternate four drive screw arrangement, in which the free end of each screw shaft 8 is rotatably attached via a rotating joint 16 to the motor 2 of an adjacent drive screw 4.

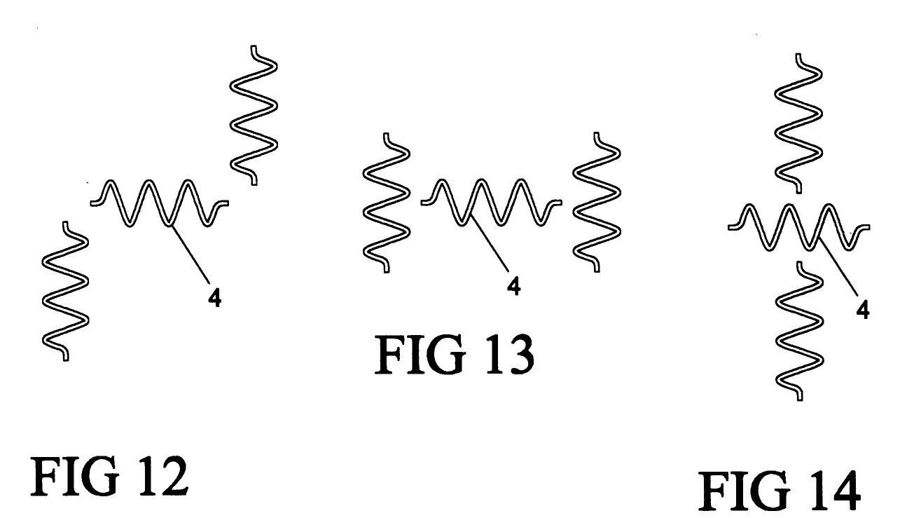

(2) 3 screws, with a central screw replacing two parallel screws, and having two-fold polar symmetry
The embodiments with two screws 4 perpendicular to the third, is shown in FIGS. 12, 13 and 14. These drive screws 4 are shown central shafts at each end, and without gear motors, since various drive arrangements can be used depending on space considerations and rotary power systems. These arrangements typically would need a suspension. The device can again travel straight in an efficiency mode, with two parallel drive screws 4 driving and the perpendicular drive screw 4 sliding as a runner with minimum resistance, or vice versa. Note the same principle applies with additional screws, for example with a total of five or seven, with the two-fold polar symmetry. In addition to full three degree of freedom capabilities on outdoor terrain, with this arrangement the invention can also travel over smooth and hard surfaces for short distances by running on the two parallel drive screws 4 and letting the third drive screw 4 slide. With the majority of the weight on the two parallel drive screws 4, those screws 4 roll together like cylinders, and the helical edge profiles 6 do not dig into the ground material. Note that this means that the invention does not have three degree of freedom capabilities while traveling on smooth hard surfaces. However, the device can move in skid-steer fashion, and additionally, the third drive screw 4 can be moved sideways.

(3) Three or more screws, in which either 2-fold symmetry is absent, or the screws are neither parallel nor perpendicular
This arrangement precludes the efficiency mode but may have other advantages in configuration. With three or more drive screws 4 in almost any arrangement, such that the ground tangent lines of at least two drive screws 4 are not parallel, the device still has full three degree of freedom capabilities.

Lastly, it is apparent that other variations are also satisfactory when all drive screws 4 are not identical in terms of helix angles 15. In the preferred embodiment, the drive screws 4 all have the same helix angle, and all the screws may be identical in all respects, if desired. If all the drive screws 4 on the device do not have the same helix angle, then the critical relationship is that of the ground tangent lines 11.

Regardless of the angle between any two drive screw axes, the helix angle 15 for any of the drive screws 4, or the right- or left-handedness of any drive screw 4, the ground tangent lines 11 of at least two drive screws 4 must not be parallel. If all the ground tangent lines are parallel, the device will not have three degree of freedom capabilities.

It may be it is preferable that the adjacent line contact angle 14 is 90 degrees, so that the device can travel in a straight line with one or two stationary drive screws 4 having ground tangent lines 11 parallel to the direction of motion, thus minimizing friction and energy usage. If the drive screws 4 have different helix angles, the ground tangent lines 11 can be at right angles or parallel without the drive screw axes being at right angles or parallel, respectively.

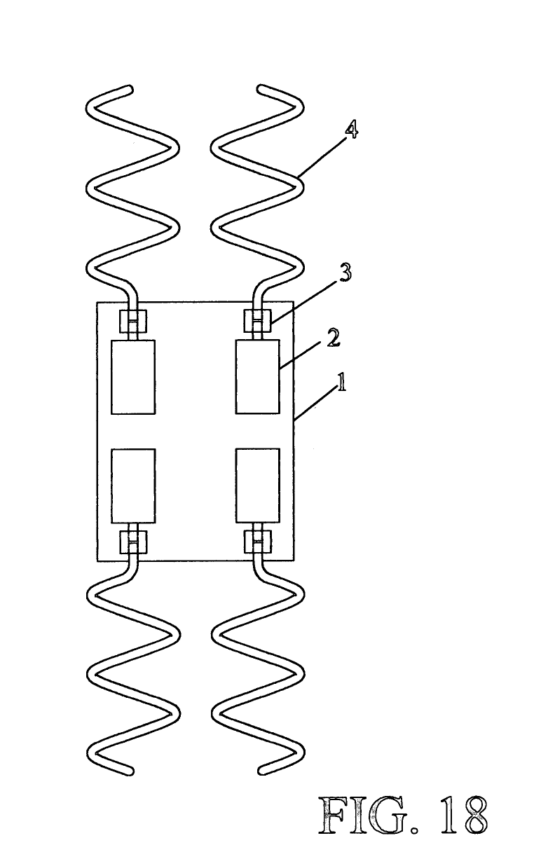

If the device uses both right hand and left hand helix drive screws 4, all screws can be parallel, as shown in FIG. 18. Note that, if the helix angle is 45 degrees, the adjacent line contact angle 14, is still 90 degrees.

While the present invention has been described with reference to several particular example embodiments, those skilled in the art will recognize that many changes may be made

I claim:

1. A screw driven mobile base assembly for traversing terrain comprising:
(a) at least three drive screws, each said drive screw having a linear axis and an outermost helical edge profile including a terrain contacting outer surface of abrasion-resistant, low friction material, said helical edge profile having a curved cross-section at the terrain contacting outer surface, said helical edge profile following a path of essentially constant helix angle relative to said linear axis of each said drive screw;
(b) a dedicated rotary power system operatively connected to each said drive screw, said dedicated rotary power system providing each said drive screw variable rotational movement in a selected direction;
(c) support and orienting means for positioning said linear axes of said at least three drive screws in a common plane with said linear axes having a selected angular spacing there between, such that at least two said drive screws produce nonparallel terrain tangent lines; and
(d) control means for controlling said dedicated rotary power systems to provide independent, coordinated rotary movement in a selected direction to each said at least three drive screws.

2. The screw driven mobile base assembly according to claim 1 wherein, said support and orienting means is secured only to said dedicated rotary power systems connected to each said at least three drive screws.

3. The screw driven mobile base assembly according to claim 1 wherein, said support and orienting means is secured both to said dedicated rotary power systems and to each said at least three drive screws.

4. The screw driven mobile base assembly according to claim 1 further including means for suspension of each said at least three drive screws for optimizing contact of said at least three drive screws outermost helical edge profile with the terrain.

5. The screw driven mobile base assembly according to claim 4 wherein, said suspension means includes a non-rigid coupling member connecting said dedicated rotary power system and each said at least three drive screws.

6. The screw driven mobile base assembly according to claim 1 wherein, said dedicated rotary power system includes an energy source and a motor operatively connected to each said at least three drive screws.

7. The screw driven mobile base assembly according to claim 6 wherein, said energy source is a battery and said motor is an electric motor.

8. The screw driven mobile base assembly according to claim 1 wherein, each said at least three drive screws includes a drive shaft on the drive screw linear axis.

9. The screw driven mobile base assembly according to claim 8 wherein, each said at least three drive screws drive shaft is operatively connected only at one end to said dedicated rotary power system.

10. The screw driven mobile base assembly according to claim 8 wherein, each said at least three drive screws has an auger structure with the drive shaft operatively connected to said dedicated rotary power system.

11. The screw driven mobile base assembly according to claim 8 wherein, each said at least three drive screws has a coil spring structure with the drive shaft operatively connected to said dedicated rotary power system.

12. The screw driven mobile base assembly according to claim 8 wherein, each said at least three drive screws has a buoyant member supporting said helical edge profile with the drive shaft operatively connected to said dedicated rotary power system.

13. The screw driven mobile base assembly according to claim 1 wherein, the helical edge profile has an inner cross-section selected from the group comprising circular, oval, triangular, multi-lobe, and unsymmetrical closed curve.

14. A screw driven mobile base assembly for traversing terrain comprising;
(a) at least three drive screws, each said drive screw having a linear axis and an outermost helical edge profile including a terrain contacting outer surface of abrasion-resistant, low friction material, said helical edge profile having a curved cross-section at the terrain contacting outer surface, said helical edge profile following a path of essentially constant helix angle relative to said linear axis of each said drive screw;
(b) a dedicated rotary power system including an energy source and a motor, operatively connected to each said drive screw, said dedicated rotary power system providing each said drive screw variable rotational movement in a selected direction;
(c) support and orienting means for positioning said linear axes of said at least three drive screws in a common plane with said linear axes having a selected angular spacing there between, such that at least two said drive screws produce nonparallel terrain tangent lines; and
(d) control means for controlling said dedicated rotary power systems motors to provide independent, coordinated rotary movement in a selected direction to each said at least three drive screws.

15. The screw driven mobile base assembly according to claim 14 wherein, said support and orienting means is secured only to said dedicated rotary power systems connected to each at least three drive screws.

16. The screw driven mobile base assembly according to claim 14 wherein, said support and orienting means is secured both to said dedicated rotary power systems and to each said at least three drive screws.

17. The screw driven mobile base assembly according to claim 14 further including means for suspension of each said at least three drive screws for optimizing contact of said at least three drive screws outermost helical edge profile with the terrain.

18. The screw driven mobile base assembly according to claim 17 wherein, said suspension means includes a non-rigid coupling member connecting said dedicated rotary power system and each said at least three drive screws.

19. The screw driven mobile base assembly according to claim 14 wherein, said energy source is a battery and said motor is an electric motor.

20. The screw driven mobile base assembly according to claim 14 wherein, each said at least three drive screws has an auger structure with a drive shaft on the drive screw linear axis, said drive shaft operatively connected only at one end to said dedicated rotary power source.

21. The screw driven mobile base assembly according to claim 14 wherein, each said at least three drive screws has a coil spring structure with a drive shaft on the drive screw linear axis, said drive shaft operatively connected only at one end to said dedicated rotary power source.

22. The screw driven mobile base assembly according to claim 14 wherein, each said at least three drive screws has a buoyant member supporting said helical edge profile with a drive shaft on the drive screw linear axis, said drive shaft operatively connected only at one end to said dedicated rotary power system.

23. The screw driven mobile base assembly according to claim 14 wherein, the helical edge profile has an inner cross-section selected from the group comprising circular, oval, triangular, multi-lobe and unsymmetrical closed curve.

24. A screw driven mobile base assembly for traversing terrain comprising;
(a) at least three drive screws, each said drive screw having a linear axis and an outermost helical edge profile including a terrain contacting outer surface of abrasion-resistant, low friction material, said helical edge profile having a curved cross-section at the terrain contacting outer surface, said helical edge profile following a path of essentially constant helix angle relative to said linear axis of each said drive screw;
(b) a dedicated rotary power system including an energy source and a motor, operatively connected to each said drive screw, said dedicated rotary power system providing each said drive screw variable rotational movement in a selected direction;
(c) support and orienting means for positioning said linear axes of said at least three drive screws in a common plane with said linear axes having a selected angular spacing there between, such that at least two drive screws produce nonparallel terrain tangent lines;
(d) control means for controlling said dedicated rotary power systems motors to provide independent, coordinated rotary movement in a selected direction to each said at least three drive screws; and
(e) means for suspension of each said at least three drive screws for optimizing contact of said at least three drive screws outermost helical edge profile with the terrain.

25. The screw driven mobile base assembly according to claim 24 wherein, said support and orienting means is secured only to said dedicated rotary power systems connected to each said at least three drive screws.

26. The screw driven mobile base assembly according to claim 24 wherein, said support and orienting means is secured both to said dedicated rotary power systems and to each said at least three drive screws.

27. The screw driven mobile base assembly according to claim 24 wherein, said suspension means includes a non-rigid coupling member connecting said dedicated rotary power system and each said at least three drive screws.

28. The screw driven mobile base assembly according to claim 24 wherein, said energy source is a battery and said motor is an electric motor.

29. The screw driven mobile base assembly according to claim 24 wherein, each said at least three drive screws has an auger structure with a drive shaft on the drive screw linear axis, said drive shaft operatively connected only at one end to said dedicated rotary power source.

30. The screw driven mobile base assembly according to claim 24 wherein, each said at least three drive screws has a coil spring structure with a drive shaft on the drive screw linear axis, said drive shaft operatively connected only at one end to said dedicated rotary power source.

31. The screw driven mobile base assembly according to claim 24 wherein, each said at least three drive screws has a buoyant member supporting said helical edge profile with a drive shaft on the drive screw linear axis, said drive shaft operatively connected only at one end to said dedicated rotary power system.

32. The screw driven mobile base assembly according to claim 24 wherein, the helical edge profile has an inner cross-section selected from the group comprising circular, oval, triangular, multi-lobe and unsymmetrical closed curve.
